(19) United States
(12) Patent Application Publication
(10) Pub. No.: US 2009/0262967 A1
(43) Pub. Date: Oct. 22, 2009

(54) WEARABLE SPEAKER VEST/JACKET

(76) Inventor: ANN MARIE J. BRYAN, New York, NY (US)

Correspondence Address: NOTARO & MICHALOS P.C., 100 DUTCH HILL ROAD, SUITE 110, ORANGEBURG, NY, 10962-2100, US

(21) Appl. No.: 12/488,473

(22) Filed: Jun. 19, 2009

Related U.S. Application Data
(63) Continuation of application No. 10/796,687, filed on Dec. 29, 2004.

(51) Int. Cl. H04R 1/02

(52) U.S. Cl. 381/333

(57) ABSTRACT

A vest for a hearing impaired wearer has panels for covering areas of the wearer, removable sleeves, a wristwatch on one sleeve and speakers mounted to the respective panels for receiving signals to generate vibrations, the mounting of the speakers being adapted for transmitting vibrations to the wearer's body.

### CROSS-REFERENCE TO RELATED APPLICATION

This is a continuation of application Ser. No. 10/796,687 originally filed on Mar. 7, 2004 and that claimed priority on provisional application No. 60/453,137 filed on Mar. 7, 2003, which is priority claims is repeated here. Both of these prior applications are incorporated here by reference.

### FIELD AND BACKGROUND OF THE INVENTION

The invention is wearable vest or jacket for the hearing impaired wearer, having various garment parts along with speakers that generate vibrations, mounted for transmitting these vibrations to the wearer and with removable sleeves that come with a sport wrist watch and hood with speaker headphones. A transducer and wireless subwoofer with solar power and Wi-Fi are included.

Aura Sound, Inc. sold a product called the Aura Interactor—Virtuality Game Wear that is a hard black plastic construction backpack-like instrument. Even though they call it a vest, and it does not appears to be one. It was originally developed for use on the Sega Genesis and Super Nintendo games. This device comes with an AC power adaptor, a control unit, cables, and the backpack that gives one feedback from the game. The Aura Interactor—Virtual Reality Game Wear does not make this unit anymore. The company pulled the products from the market in 1995, and no longer producing them. The problems with this unit is that you are strapped to it, a quick and easy task, but somehow the act of strapping a piece of hardware on to your body is itself an act of commitment. In other word, you can't just walk away from your computer to walk your dog or go jogging until you have either unplugged the device or taken the unit off.

In an article about this unit, Aura Interactor Review, dated 8 Jan., 2002, the author Jon Thysell, wrote:
“AURA INTERACTOR VIRTUAL REALITY GAME WEAR PAST ITS PRIME?
   I'll be brutally honest: it was cool for a little while. But after wearing it for about an hour listening to some music, it made me feel sick to my stomach. All that vibrating around can get annoying; you can't concentrate at all while wearing it. It isn't so bad in slower paced games like the various Rainbow Six® games, but playing with it in something that requires fast reflexes and concentration like Counter-Strike will just drive you insane.
   If you think back to 1994, back when the hottest gaming systems were the Sega® Genesis™ and Super Nintendo®, it would be just fine. But with all of the more recent high intensity games, the Aura Interactor falls short. It should have had a headphone jack though, and a way to mute the garbled sounds coming from the backpack.”

Since Aura ceased this product because their unit did not do well in the market due to some flaws, sound defects, being confined to wires, and to the AC outlet. Apparently, Aura did not catch on to improve their unit. Based on research, most of their consumers were Deaf and Hard of Hearing. Aura had no interest of plans to advance their technology invention to produce them wireless.

### SUMMARY OF THE INVENTION

My device was discovered by accident during a movie production. It was created as a piece of prop in the film to allow a deaf actress to feel her musician boyfriend's music through a “homemade” wearable speaker vest model made out of car speakers. The only disadvantage was the wires, which were in the way due to being attached to the speakers sewn onto the vest and the car speakers were heavy. However, the sensational feeling of the bass was effective.

As a deaf person, I enjoy music very much, so does the thousand and thousands of Deaf and Hard of Hearing people from all walks of lives. The inventor owned a mini-iPod, and do not get the same privilege that most hearing people do; listening and appreciate music on the road. So why don't we have some sort of “body-pod” where we can appreciate music by feeling the music on the go? Remember those days when street people would carry a “boom box” on their shoulder with the music blasting? The boom boxes are out! Now it's time for a new “ready-to-wear boom devices.

I became drawn to the idea to approach a new way to enjoy entertainment with fashion. The design of this product is to produce wearable speaker vests with removable sleeves that are to be combined with electronic components and other elements wirelessly with multifunction mechanisms. I saw an opportunity to market the innovative product when I release my movie in the near future.

Since ten years ago when Aura created the Virtual Reality Game Wear backpack, Technology has advanced. My plan is to introduce a fun, fashionable and entertaining transducer speaker vest/jacket for everyone to wear and to enjoy the comfort and convenience of going places wirelessly.

The Wearable Speakers Vest/Jacket is an innovative “ready-to-wear” design of the present invention that is the art of fashion, entertainment, sports, and urban trend. The device provides an alternative and convenient way of life to appreciate and feel the bass without the confinement to wires or plugs. The device is to be used with a connectivity outlet for the iPod, CD Player, PDAs, computer laptops, DVD Players, MP3 Player, and other kind of gadgets.

The vest/jacket will have several holding places fastened onto the fabric. The cloth will hold multiple flat panel speakers both front and back. The speakers will be connected to speaker wires, thereby linking to electronic magnetized cooper wires, which enable to speakers to work.

The vest/jacket will also contained sports wristwatches and bands, with Nylon strap, Velcro closure, or sewn in around the side of the armhole of the sleeves.

They are ideal as sportswear for cyclists, joggers, skateboarders, roller-bladers and so forth.

They will also come with reflectors, either on the side of the shoulder arms sleeves or on the back of the vest.

The device will also come with small speaker loop to be worn around the neck with a headphone either build inside the hood or worn externally.

There will be multiple pockets and pouches to store gadgets, keys, iPods, CD/DVD Players, small computer laptops, games, digital cameras, wallets, PDAs, removable speakers and so forth.

The speaker vest/jacket will all have transmitter and receivers built internally or externally of the vest for receptive to work with the remote wireless. They are the essential components used to operate its functionality with the headphone, speakers, and blinking reflectors.

There will patches under the elbow-level of the sleeves for blinking, reflections and protection from sports activity.

The speakers can be added anywhere, in the front or the back.

The idea is to seek a manufacturer or prototype company that will make them in a functionality form:

Wireless (battery operated)

(Wi-Fi) based radio wave

Solar sensor.

The wearable speakers vest/jacket will come in all colors, style, designs, textures and comfort.

### Who Will Benefit:

Deaf/HOH people, Urban group, Kids/Young people, African American, Latinos, Artists, Filmmakers, Street people, Computer geeksm, Rap artists, Singers, Outdoor people Musicians, and Athletes.

In summary, the idea is to allow anyone the free will to travel anywhere with the speakers vest/jacket with being connected or restrained to a plug.

We plan to also develop a mechanism that will allow Deaf people to enjoy this unit when they go to the movies. For instance, when they go to the movies, we want to design a prototype control dial button so they can set up the communicator to (M) for movie to activate the transducer to transmit and receive vibration without actually emitting audio noise or sound. Wi-Fi radio wave is an introduction to that idea.

If they want audio/music, they set up the control dial button to (A) for audio/music; they have the option of using a Cd Walkman, iPod, MP3 Player.

The goal is to make the speakers as flat as possible, with high-powered bass and lightweight as possible. I can see this device improve its elements over times as technology continues to advance.

All the speakers of the vest/jacket will have a transmitter and a receiver built internally or externally of the vest for reception to work with the remote wireless. These are the essential components used to operate with the headphone, speakers, and blinking reflectors.

There will be patches under the elbow-level of the sleeves for blinking, reflections and protection from sports activity.

Most of all, the greatest benefit of the vest of the invention is that it is charged overnight—like you would do to a massager chair with the option of using a remote control or a turn on button inserted on the vest. The same rule applies for cell phones, pagers, PDAs, computer laptops, digital cameras, and so forth. The speakers can be added anywhere, in the front or the back of the vest.

The idea is to seek a manufacturer or prototype company that will make the vest of the present invention in a functionality form.

### BRIEF DESCRIPTION OF THE DRAWINGS

In the drawings:

FIG. 1 is a front view of the vest of the invention;

FIG. 2 is a front view of a second embodiment of the vest;

FIG. 3 is a front view of a third embodiment of the vest;

FIG. 4 is a front view of a fourth embodiment of the vest;

FIG. 5 is a front view of a fifth embodiment of the vest;

FIG. 6 is a rear view of a sixth embodiment of the vest;

FIG. 7 is a front view of a seventh embodiment of the vest;

FIG. 8a is a front view of an eighth embodiment of the vest;

FIG. 8b is a rear view of the eighth embodiment of the vest;

FIG. 9a is a front view of a ninth embodiment of the vest;

FIG. 9b is a front view of a tenth embodiment of the vest;

FIG. 10a is a rear view of an eleventh embodiment of the vest with removable sleeves;

FIG. 10b is a rear view of the eleventh embodiment of the vest with the sleeves removed;

FIG. 11a is a front view of a hood of for the vest of the invention;

FIG. 11b is a front view of the hood with a wearer;

FIG. 12a is a rear view of a folded hood of for the vest of the invention;

FIG. 12b is a front view of the folded hood;

FIG. 13 is a front view of a twelfth embodiment of the vest;

FIG. 14 is a front view of a twelfth embodiment of the vest with the sleeves removed;

FIG. 15a is a front view of a thirteenth embodiment of the vest;

FIG. 15b is a front view of a fourteenth embodiment of the vest;

FIG. 16a is a front view of a fifteenth embodiment of the vest;

FIG. 16b is a perspective view of the fourteenth embodiment with a wearer shown;

FIG. 16c is a perspective view of headphones for the fourteenth embodiment;

FIG. 17a is a front view of a sixteenth embodiment of the vest;

FIG. 17b is a rear view of the sixteenth embodiment;

FIG. 17c is a front view of a seventeenth embodiment of the vest;

FIG. 17d is a rear view of the seventeenth embodiment;

FIG. 18a is a front view of an eighteenth embodiment of the vest;

FIG. 18b is a rear view of the eighteenth embodiment;

FIG. 18c is a front view of a nineteenth embodiment of the vest;

FIG. 18d is a rear view of the nineteenth embodiment;

FIG. 18e is a front view of a twentieth embodiment of the vest; and

FIG. 18d is a rear view of the twentieth embodiment.

### DESCRIPTION OF THE PREFERRED EMBODIMENTS

An object of the invention is to provide the flattest, smallest, round or square speaker transducer possible (at least 1.5 to 2 inches and weighing less than 2 lbs.) with high ends, powers and sensation feeling that consumers can appreciate (wireless) and wear the vest on the go; anytime, anywhere and any place without restriction. The speaker transducer can be placed on the back of the vest with two main speakers on top left and right and with two additional speakers on the front of the vest above the chest line or below the torso line where the pouch pockets will be. We have all the options to place the transducers, however they need to be as light as possible and small as possible.

### Wireless Transmitter/Receiver Speaker Vest

(High-Fidelity Subwoofer Also Known as Transducers/Vibrator)

The accompanying drawings further describe the invention.

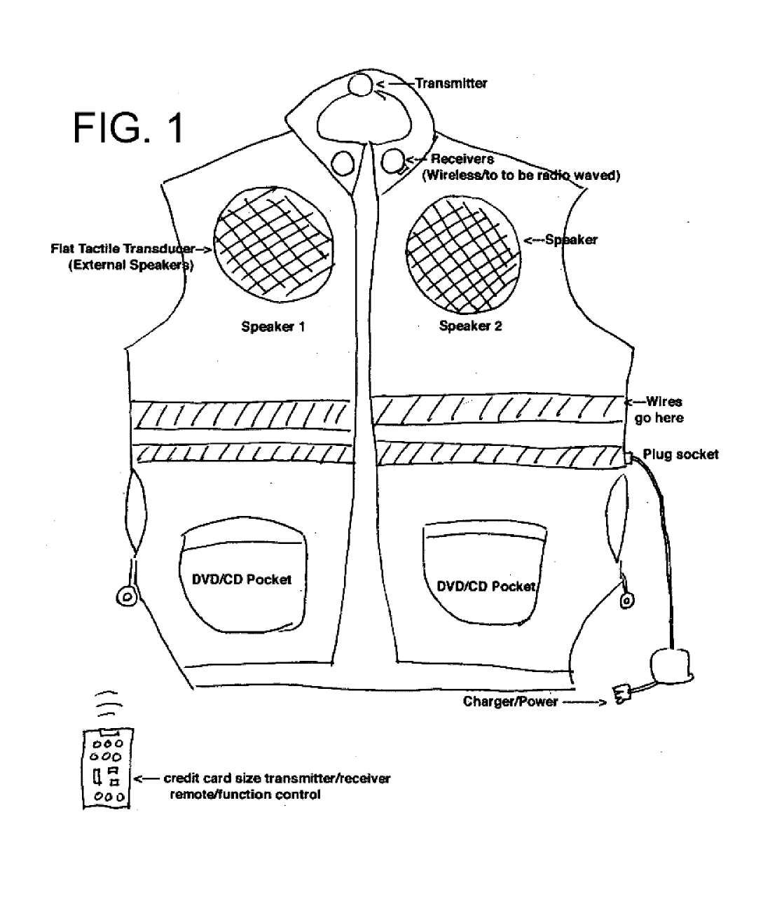

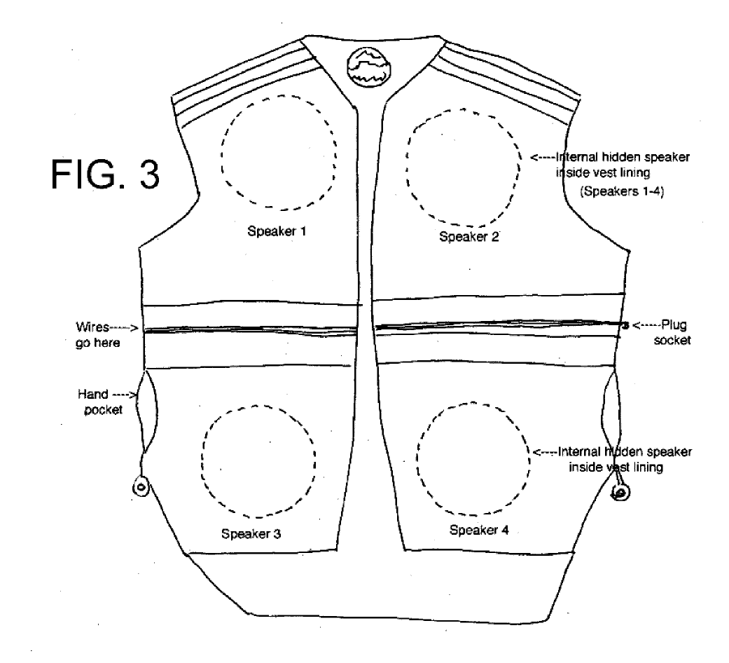

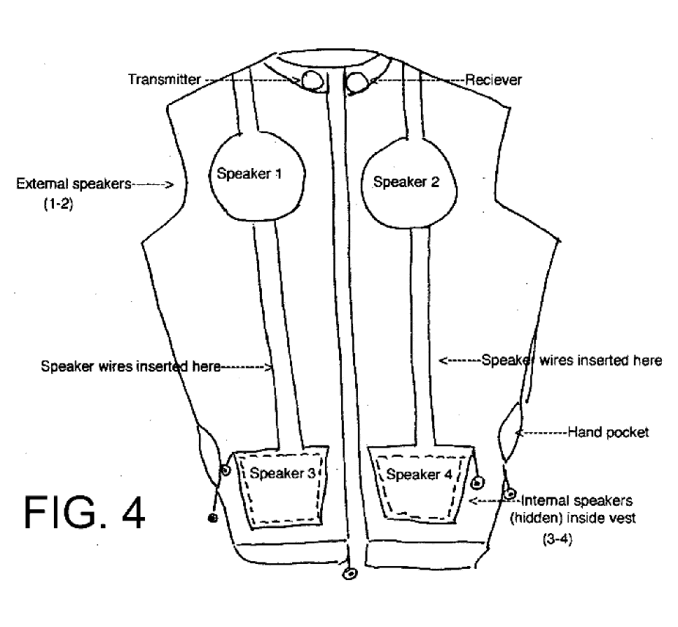

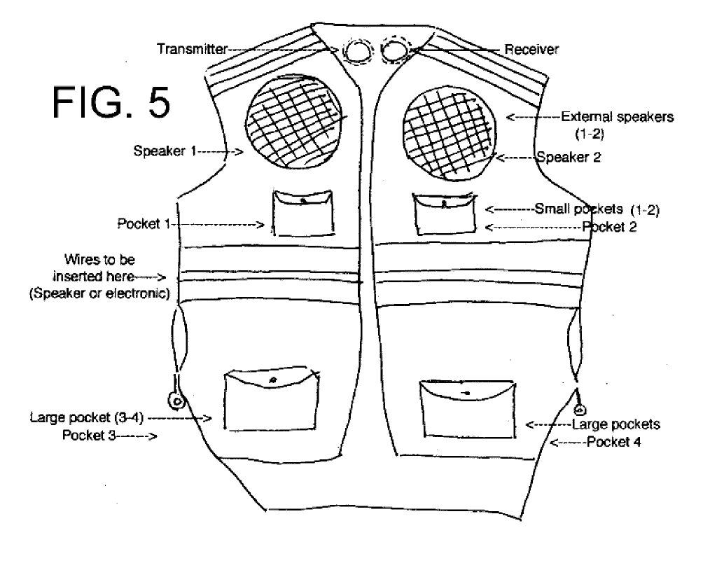

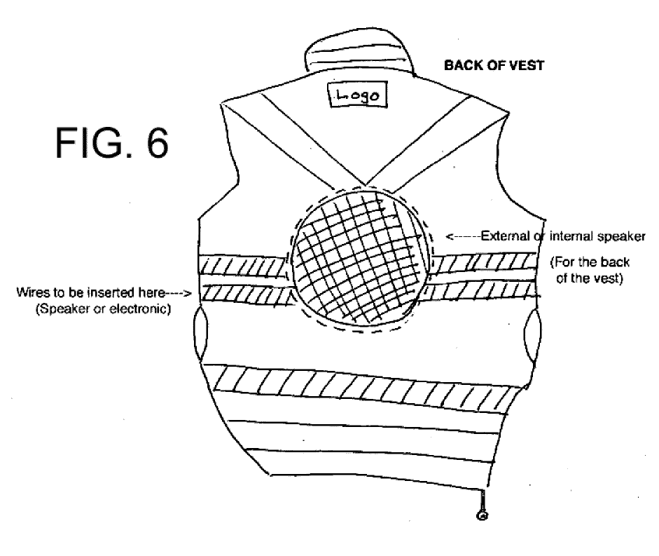

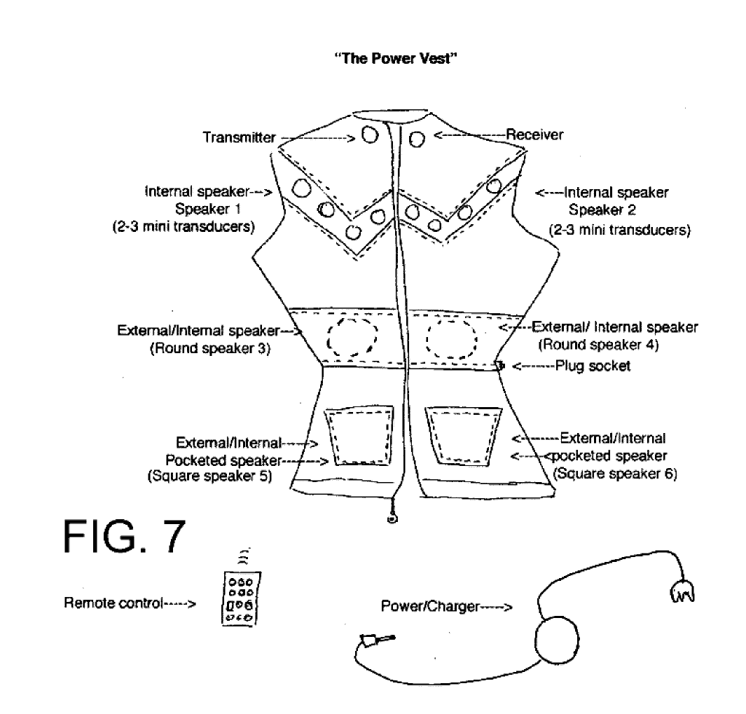

Some embodiments of the wireless wearable speakers vest of the invention are shown in FIGS. 1-7.

As shown in the drawings, the vest is a “THE POWER VEST” with features that includes:

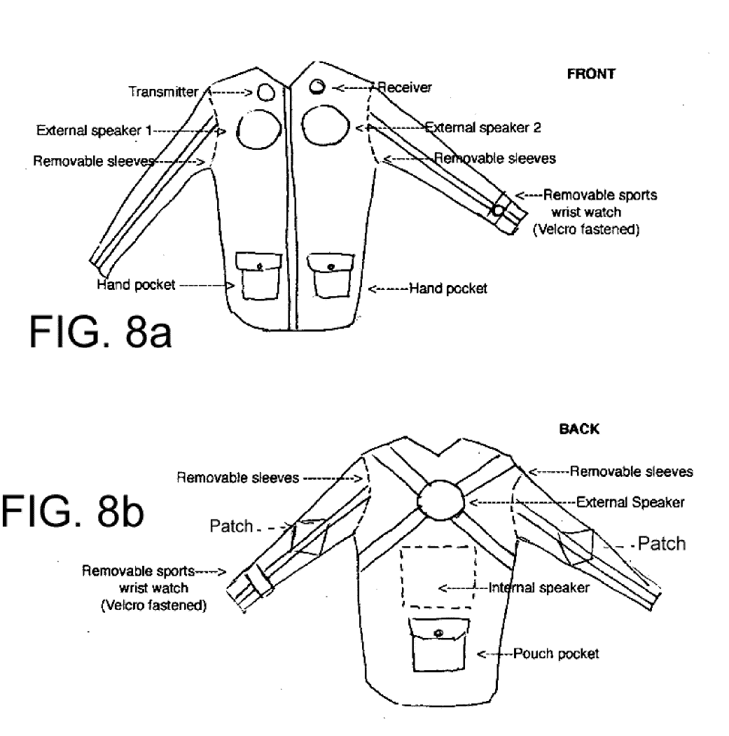

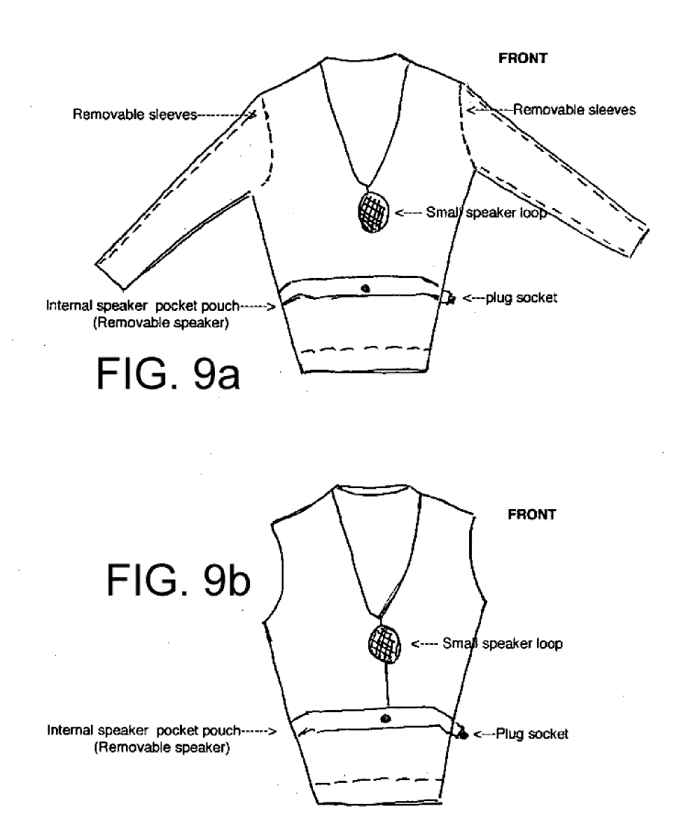

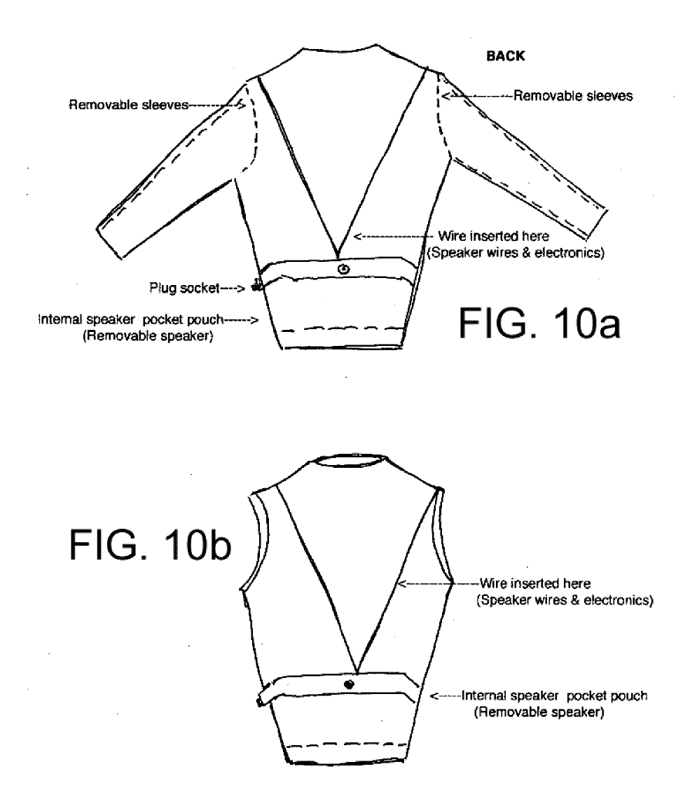

Wearable speaker vest jacket with removable sleeves and wrist watch (wireless). See FIGS. 8a, 8b, 9a, 9b, 10a, and 10b. Wearable speaker vest or jacket with headphones also known as “HOODPHONE OR HOODIES” (wireless), all in one design.

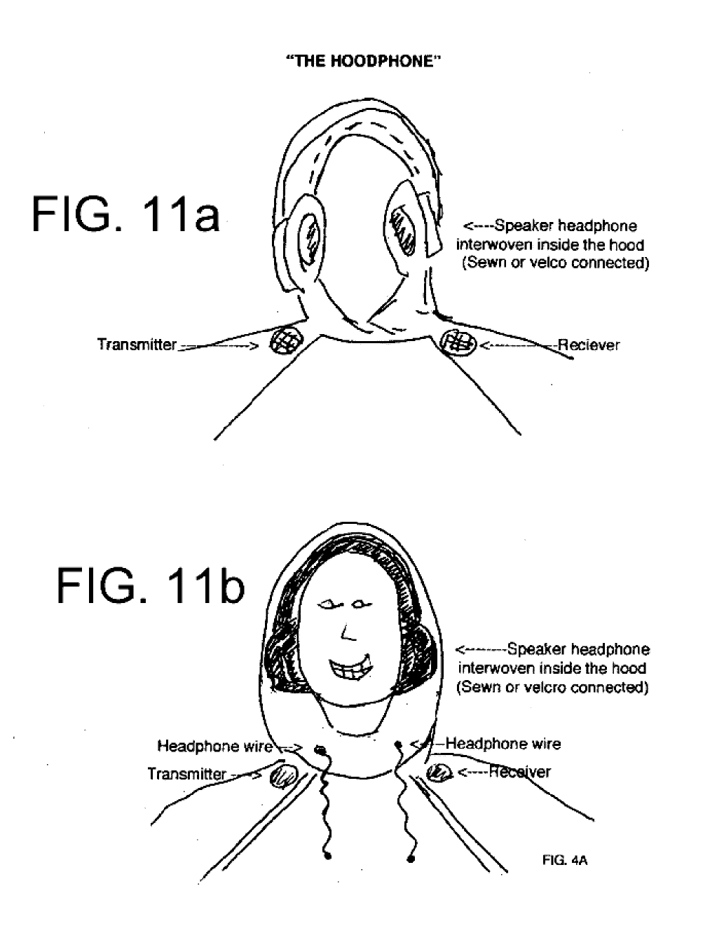

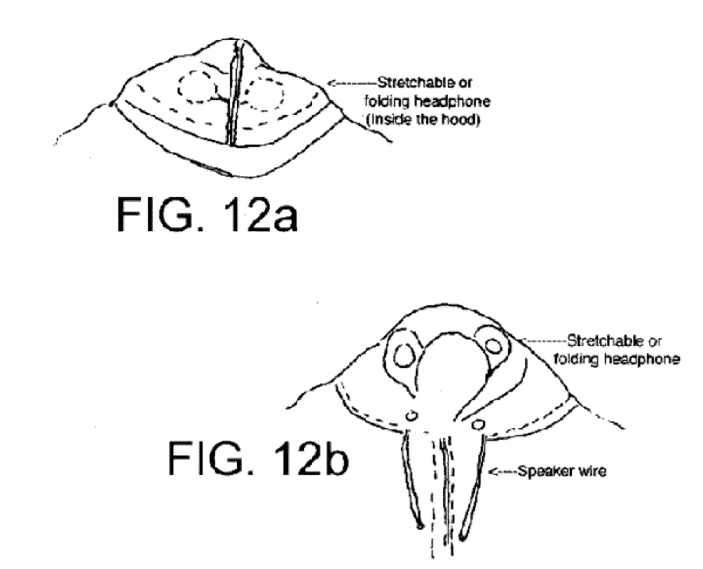

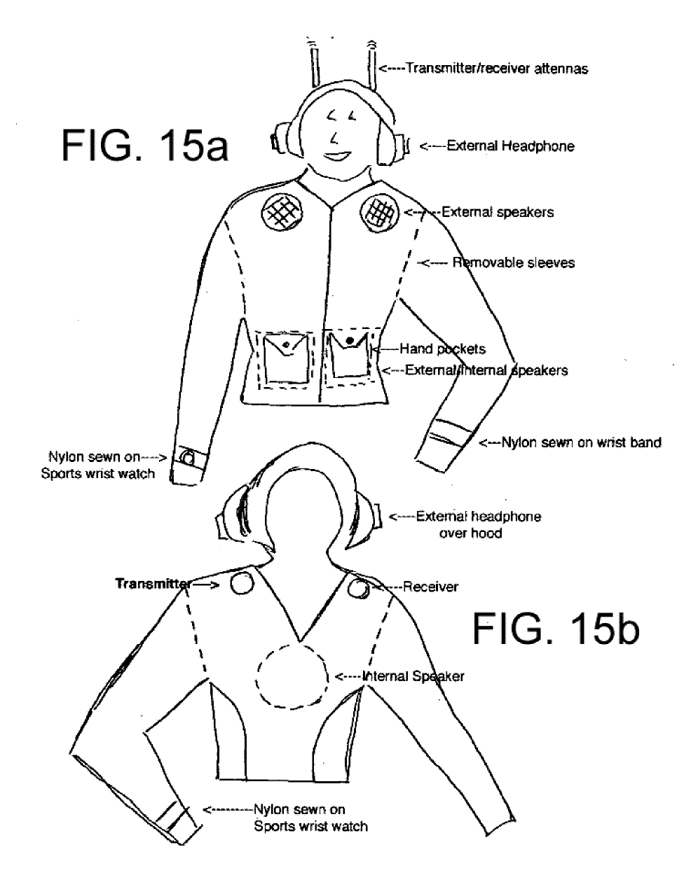

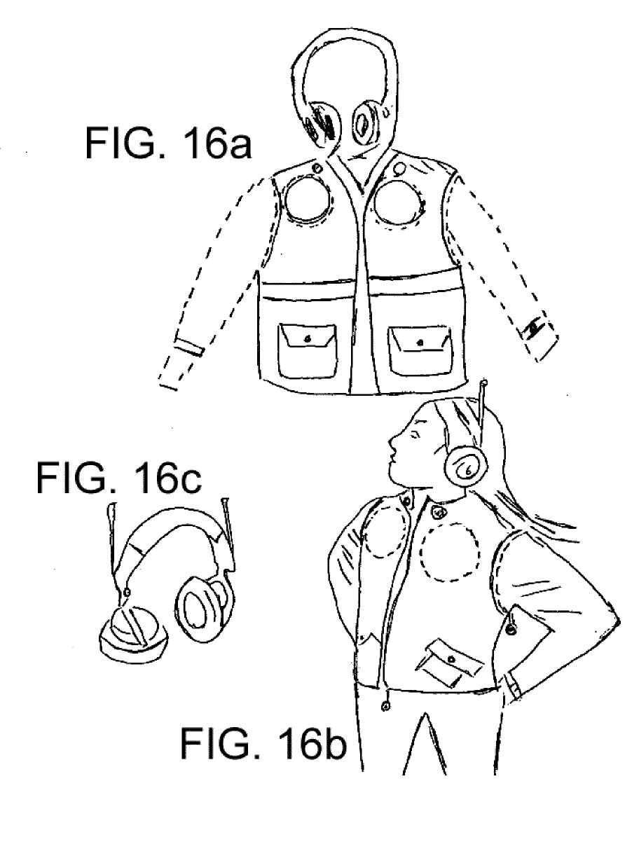

See FIGS. 11a, 11b, 12a, 12b, 13, 14, 15a, 15b, 16a, 16b and 16c.

Specialist Team

Design Engineering, Industrial Engineering and Audio Engineering.

The inventor has two brothers who are field and electronic Engineers. Consultation received from them will greatly benefit us in developing several working prototype models, especially flat panel speakers that are light as possible.

TECHNICAL (RS-426 and DIN 120 ARE COMMONLY USED) (Expected to work after evaluation and testing:

Thiele-Small Lumped Parameter Model; Thermal Power Handling; Frequency Response; Displacement Power Handling—to check for distortion; Waterfall Response; Filtering; Integration; and Impedance.

Design the most flattest, most smallest, round or square transducer (at least 1.5 to 2 inches and weighing less than 2 lbs.) with high ends, powers and sensation feeling that consumers can appreciate (wireless) and wear the vest on the go; anytime, anywhere and any place without restricts. The speaker transducer can be placed on the back of the vest with two main speakers on top left and right and with two additional speakers on the front of the vest above the chest line or below the torso line where the pouch pockets will be. We have all the options to place the transducers, however they need to be as light as possible and small as possible.

Redrock Acoustics is our main interest and reliable speaker-designing source that we'd like to collaborate for the design of the vests/jackets. Their 20 years of experiences of transducer design from Ribbon Tweets to high power subwoofers aim to meet the high demand needs of their clients.

The best acoustical products begin with a root understanding of how transducers function and end with strict quality assurance. Redrock Acoustics has some of the most sophisticated test equipment available, and in cases where commercial gear was not available, they designed their own. They are based in Tempe, Ariz. and they have the ability to perform qualitative tests that define every aspect of a speaker's performance.

We are convinced that we will find the smallest, powerful and round or square speakers.

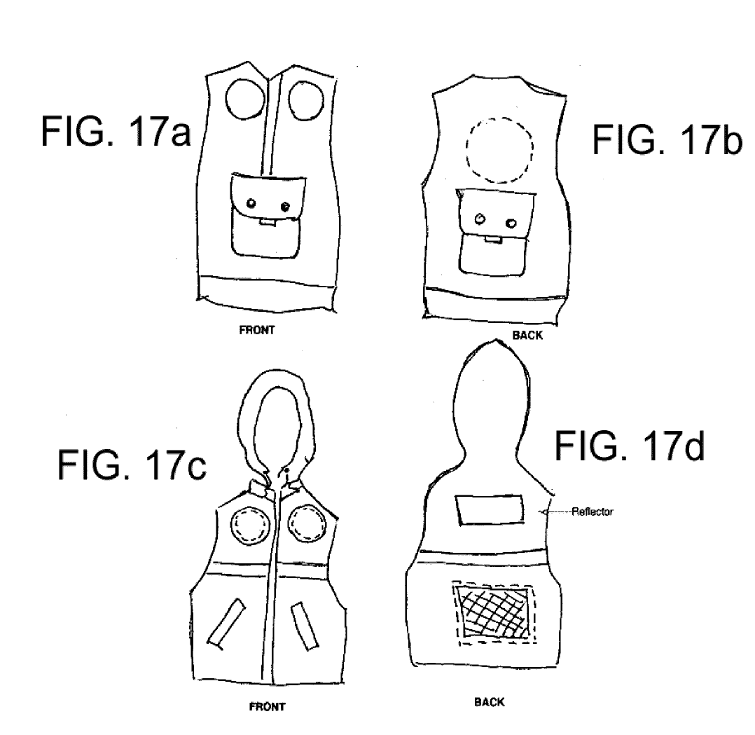

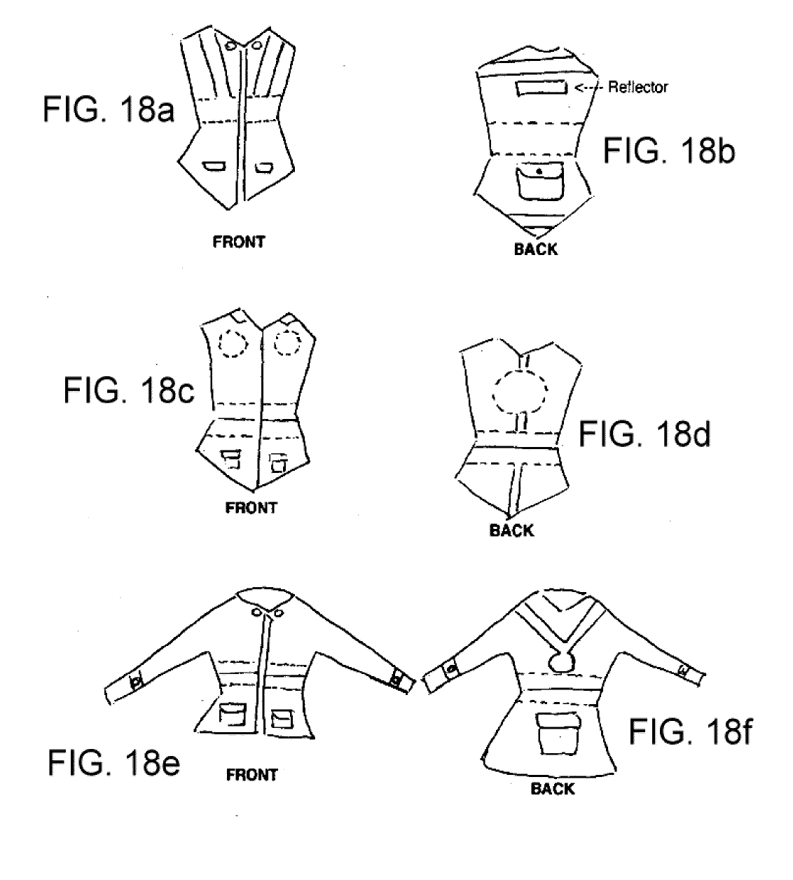

Design lightweight ski typed vests to wear for hours as well as comfort fitting as shown in FIGS. 17a, 17b, 17c and 17d. We will experiment and test a variety of vests from soft foam core, sturdy nylon, Neoprene, or polyester fabrics to see which emits more bass power and sensation from the transducer.

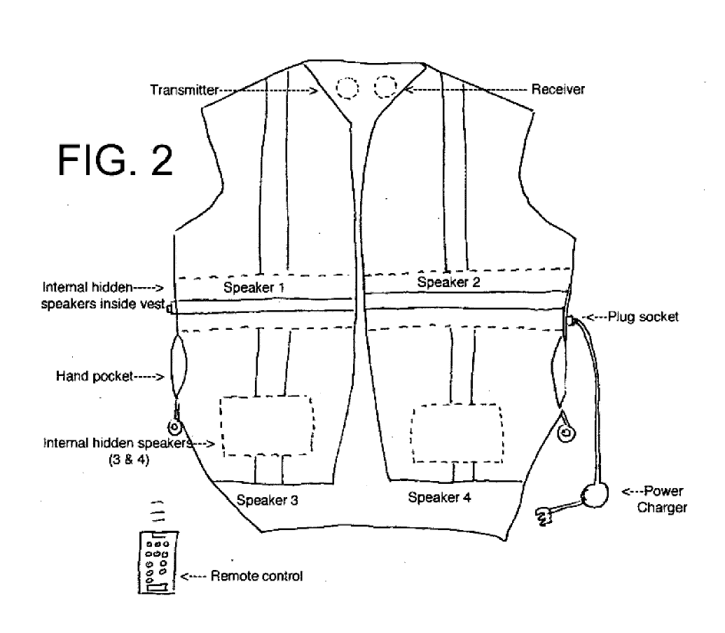

Then insert wires inside of the vest and test the power of the speakers (see FIG. 2).

To design a non-auditory transducer instrument (the kinds that could be use with gaming consoles such as PlayStation2 or Xbox—without disturbing anyone else. This idea introduction approach is ideal for Deaf and Hard of Hearing people.

To design a full-throttle sound transducer instrument without disturbing others (for non-deaf people.

Design a battery operate charger to charge the vest power.

Built-in amplified transmitter/receiver.

Design a wireless transmitting/receiving or Wi-Fi radio wave coordination, battery operated power and Solar Sensor functionality. We will test which benefits better wirelessly, and or whether transducer speaker will work well with Wi-Fi ready. Although, interference may be a problem for Wi-Fi system causing delays in communications in several Wi-fi machines since its fairly new. It is a new form of introduction to try this method and we do not know if the strength of the Wi-Fi communication can carry the power of the speakers.

Design a remote control for the vest/jacket with multifunction for multimedia functions for a wireless battery operated: CD player; Walkman; Fm/AM Radio; DVD player; Home Entertainment Unit; Games; Television; Movie theaters; Laptop; Computer; and Headphones.

Built-in control dials (i.e., switch off/on) like turning off a cell phone or pager inside the transmitter and receiver buttons on the vest. See FIGS. 1 and 2. The idea is to get the remote control and the on/off control dials on the vest to communicate with each other.

The biggest challenge there is “how do we get the speaker transducer vest (sound or no sound) to work with the multimedia entertainment technology without wire connectivity?”

Design a DVD/CD pouch pocket on the vest/jacket for easy carry around.

Design connections: Cables insert to TVs, VCRs, CD and audio systems through the supplied connecting cord and plug adapter to preserve or charge battery power.

We are prepared to design all the connections/plugs for multimedia entertainment equipment. For example: the power of the transducer vest is charged, and you're ready to go. You are ready to plug a cable of an iPod or a CD walkman into the vest plug socket. You can put them in one of the pouch pockets. You're set to go! There, you have your bass and your music rocking your body as you go in for coffee or take your dog out for a walk. You could also plug in your headphone to keep sound from coming out.

### Additional Features

Volume controls (for audio/sound options); Added voice coil but must be low frequency to induce high fidelity bass; Built in radio (FM/AM); Design removable vest sleeves and design sport; Wristwatches on one of the sleeves; an Built-in wireless superbass headphone to be sewn inside the hood or out.

### Headphone Details

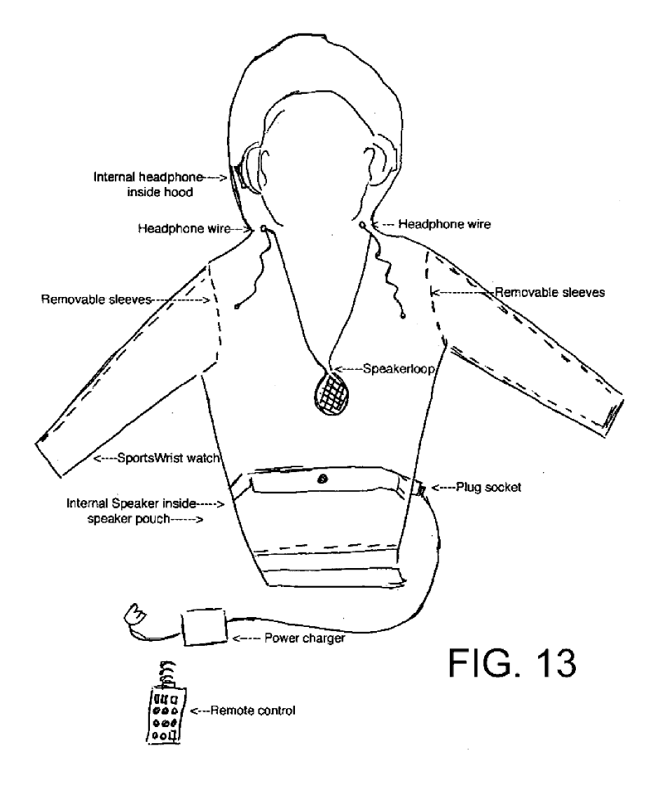

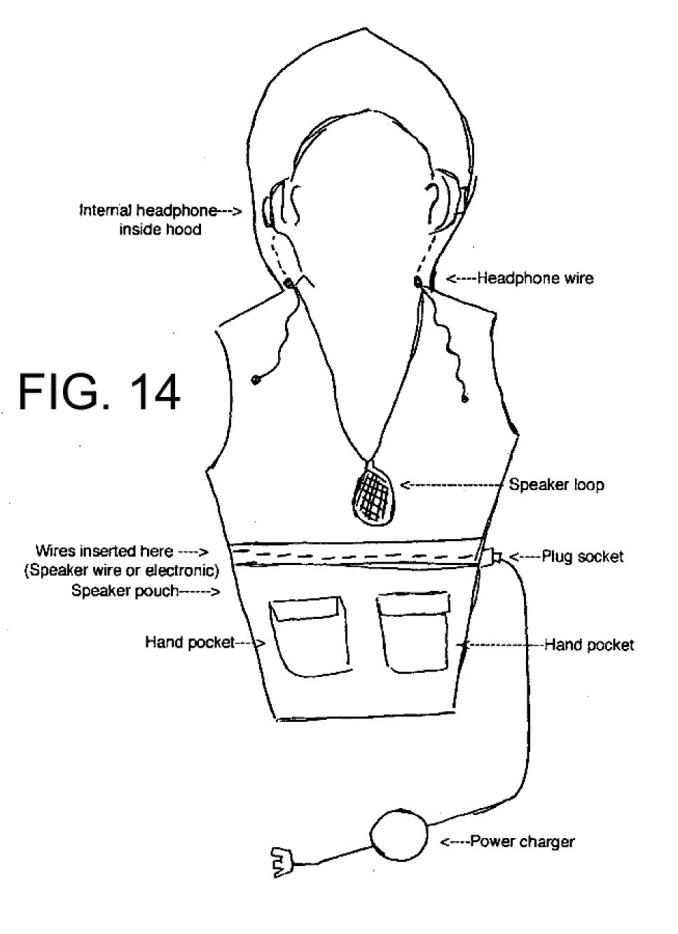

See FIGS. 11, 12, 13, 14, 15 and 16. FIGS. 13 and 14 in particular show the invention. Design a built-in HOOD-PHONE (speaker headphone) ideal for skiers, joggers, cyclists, and outdoor athletes. Design a lightweight waterproof foldable headphone inside the hood. Create an open-air or compressed design that lets you continue to hear ambient sound. 30 mm diameter drive units. These internal drivers are larger than on many other portable headphones, resulting in deeper bass, lower distortion and wider dynamic range. Frequency response extends down to a low 18 Hz. 90° transmission angle (maximum) for uninterrupted listening as you move around the room. PET diaphragms: ensure high rigidity for minimum distortion; low mass for extended high-frequency response out to 22,000 Hz. Wide headband: with a separate self-adjusting band conforms precisely to the curve of your head; stays comfortable, even after listening for hours on end. Mute function: to avoid noise through the headphones; cuts out the sound when no audio signal is available. Automatic power switch: for both the headphones and transmitter conserves battery life; when the transmitter senses an input signal, it turns on; the headphones turn on when you place them on your head.

Additional features are: Single volume control: in one earpiece conveniently adjusts the volume for both channels; Built-in antenna for better reception (wireless-Wi-Fi ready); and Build an infrared technology less prone to Interference.

Unlike most other cordless headphones, which typically use radio frequency signals, these headphones use infrared technology. This makes them less prone to interference from other household items that use radio frequency technology, like cordless phones. Plus, multiple LEDs provide an extended 24′ coverage range (line of sight).

### Headphones

Type—Open-air or compressed, Dynamic, Cordless

Drive Unit—20-40 mm

Frequency Response—18-22,000 Hz

Power Requirements—DC 1.5V, 1 NiCad Rechargeable Battery (supplied) or 1 AA battery (optional)

Battery Life—Approx. 23 hours with supplied NiCad battery; approx. 45 hours with optional alkaline battery

Recharging Time—Approx. 24 hours

Supplied Accessories—Rechargeable NiCad Battery NC-AA-HJ

AC adapter

UniMatch plug adapter

Connecting cord.

Weight—Headphones: 6.3 oz. (180 g), (including battery)

Transmitter: 4.4 oz. (125 g)

### Headphone Transmitter

Power Requirements—AC 120V, 60 Hz when used with supplied AC power adaptor, which connects to the DC 9V jack

Audio Input—Stereo L/R phono plugs; supplied 3-foot connecting cord goes from stereo mini plug or phone plug to L/R phono plugs

Expect effective Range—24 feet 10 feet

Power On/Off—Automatic On/Off switch.

We will design and test the strength of the bass power far greater than what the normal frequency ears listens to music or sound since most Deaf people like more bass coming from the headphone. It will be designed for Deaf people only.

The purpose is to give them vibrating bass enhancement provides extra power without extra volume needed.

Current designs (photo samples) are still in early stage of development. It was use as props for a movie production. Again, we saw a greater market opportunity for the speaker vest.

Therefore, we believe as the product and the technical develops with the participation of engineers in the expertise in electronic and magnetic, it is our intention to seek a manufacturer that can make them as flat as possible to wear wirelessly.

In conclusion, the above description and examples should not be construed as limitations on the scope of the invention. Many other variations are possible. Accordingly, the scope of the invention is determined by the claims and their legal equivalents.

What is claimed is:

1. A vest for a hearing impaired wearer, comprising:
a left and a right front panel for covering respective left and right chest areas of the wearer, each front panel having an upper collar portion and a vest lining;
a rear panel having opposite side edges connected respectively to the front panels for covering a back area of the wearer, and defining with the front panels, left and right sleeve openings, the rear panel having an upper collar portion and a further vest lining;
a left and a right sleeve each removably connected to one of the sleeve openings for covering left and right arms of the wearer;
a wristwatch removably connected to one of the sleeves;
a left and a right speaker mounted to the respective left and right front panels for receiving signals to generate vibrations, the mounting of the left and right speakers being adapted for transmitting vibrations to the chest areas of the wearer;
a rear speaker mounted to the rear panel for receiving signals to generating vibrations, the mounting of the rear speaker being adapted for transmitting vibrations to the back area of the wearer;
a plug socket near one of the side edges of the rear panel for connecting at least one of a sound generating device and a power charger to the speakers;
at least one wireless receiver mounted to the collar portion of at least one of the front and rear panels for sending sound signals to the speakers;
at least one blinking reflector on at least one of the front panels, the rear panel and the sleeves, said reflector being used for reception of signals to the vest;
at least one rechargeable battery connected to the at least one wireless receiver for powering the receiver;
charging means detachably connected to the rechargeable battery for recharging the battery; and
at least one pocket in each of the front panels, a sound generating device in at least one of the pockets, and a credit card size remote control in combination with the vest for remotely controlling the sound generating device;
the sound generating device being selected from the group consisting of: a CD player, an MP3 player, a radio, a computer, a DVD player, a game, and a television.

2. The vest of claim 1, including a hood connected to the collar portions and containing a built-in headphone for the wearer.

3. The vest of claim 2, including a hood connected to the collar portions and containing a built-in headphone for the wearer.

4. The vest of claim 3, wherein the speakers are internal and are mounted within the vest linings.

5. The vest of claim 4, including a hood connected to the collar portions and containing a built-in headphone for the wearer.

6. The vest of claim 5, including a wireless transmitter connected to one of the collar portions.

7. The vest of claim 6, including a wireless transmitter connected to one of the collar portion.

8. The vest of claim 7, wherein the receiver is mounted to one of the collar portions of one of the front panels, the vest including a transmitter connected to the collar portion of the other front panel.
